(19) United States
(12) Patent Application Publication
(10) Pub. No.: US 2026/0195914 A1
(43) Pub. Date: Jul. 9, 2026

(54) SYSTEM AND METHOD FOR APPLYING MACHINE LEARNING TO DETERMINE POROSITY LOGS USING CORE PHOTOS

(71) Applicant: Saudi Arabian Oil Company, Dhahran (SA)

(72) Inventors: Mokhles Mustapha Mezghani, Dhahran (SA); Mandefro Belayneh Woldeamanuel, Dhahran (SA); Aqeel Khalifa, Dammam (SA)

(73) Assignee: Saudi Arabian Oil Company, Dhahran (SA)

(21) Appl. No.: 19/010,994

(22) Filed: Jan. 6, 2025

(51) Int. Cl. G06T 7/62; G01V 11/00; G06T 7/11; G06T 7/174

(52) U.S. Cl. CPC G06T 7/62; G01V 11/002; G06T 7/11; G06T 7/174; G06T 2207/20081; G06T 2207/20084; G06T 2207/30181

(57) ABSTRACT

A method for determining a porosity log of a log type for a hydrocarbon reservoir, including: obtaining an input core image, a formation bulk log of the log type, and a formation fluid log of the log type for the reservoir; determining, using a segmentation model and the input core image, a segmented core image to delineate a distribution along the reservoir; determining, using the segmented core image, a volumetric log for the reservoir; determining, using the volumetric log and a variable rock matrix value of the log type, a rock matrix log of the log type by assigning the variable rock matrix value of the log type to a lithology or mineralogy; and determining, using the rock matrix log, the formation bulk log of the log type, and the formation fluid log of the log type, the porosity log of the log type for the reservoir.

### TECHNICAL FIELD

Embodiments of the disclosure generally relate to reservoir characterization and, more particularly, to the determination of porosity logs using core images.

### BACKGROUND

A rock formation that resides under the Earth's surface is often called a “subsurface” formation. A subsurface formation that contains a subsurface pool of hydrocarbons, such as oil and gas, is usually referred to as a “hydrocarbon reservoir.” Hydrocarbons are typically extracted (or “produced”) from a hydrocarbon reservoir by way of a hydrocarbon well. A hydrocarbon well normally includes a wellbore (or “borehole”) that is drilled into the reservoir. For example, a hydrocarbon well may include a wellbore that extends into the rock of a reservoir to facilitate the extraction (or “production”) of hydrocarbons from the reservoir, the injection of fluids into the reservoir, or the evaluation and monitoring of the reservoir. Characterization of petrophysical properties for a reservoir provides important information for locating and drilling wells. For example, porosity is the percentage of the volume of void space of the total volume of the rock mass in a rock. Accurate porosity prediction of a reservoir provides useful information for the percentage of total hydrocarbons which can be produced from the reservoir over its entire lifespan.

### SUMMARY

The following presents a simplified summary of the disclosed subject matter in order to provide a basic understanding of some aspects of the subject matter disclosed herein. This summary is not an exhaustive overview of the technology disclosed herein. It is not intended to identify key or critical elements of the disclosed subject matter or to delineate the scope of the disclosed subject matter. Its sole purpose is to present some concepts in a simplified form as a prelude to the more detailed description that is discussed later.

In one or more embodiments, the present invention provides a method for determining a porosity log of a log type for a hydrocarbon reservoir. The method includes obtaining an input core image, a formation bulk log of the log type, and a formation fluid log of the log type for the reservoir. The method further includes determining, using a segmentation model and the input core image, a segmented core image to delineate a distribution along the reservoir, such that the distribution includes a lithology distribution, a mineralogy distribution, or a combination thereof. The method further includes determining, using the segmented core image, a volumetric log, such that the volumetric log includes a lithology volumetric log, a mineralogy volumetric log, or a combination thereof. The method further includes determining, using the volumetric log and a variable rock matrix value of the log type, a rock matrix log of the log type by assigning the variable rock matrix value of the log type to a lithology or mineralogy. The method further includes determining, using the rock matrix log of the log type, the formation bulk log of the log type, and the formation fluid log of the log type, the porosity log of the log type for the reservoir.

In one or more embodiments, the present invention provides a system for determining a porosity log of a log type for a hydrocarbon reservoir. The system may include a processor and a computer-readable non-transitory storage medium including instructions that, when executed by the processor, cause the processor to perform operations. The operations include obtaining an input core image, a formation bulk log of the log type, and a formation fluid log of the log type for the reservoir. The operations further include determining, using a segmentation model and the input core image, a segmented core image to delineate a distribution along the reservoir, such that the distribution includes a lithology distribution, a mineralogy distribution, or a combination thereof. The operations further include determining, using the segmented core image, a volumetric log, such that the volumetric log includes a lithology volumetric log, a mineralogy volumetric log, or a combination thereof. The operations further include determining, using the volumetric log and a variable rock matrix value of the log type, a rock matrix log of the log type by assigning the variable rock matrix value of the log type to a lithology or mineralogy. The operations further include determining, using the rock matrix log of the log type, the formation bulk log of the log type, and the formation fluid log of the log type, the porosity log of the log type for the reservoir.

In one or more embodiments, the present invention provides a non-transitory computer-readable medium having instructions that, when executed by a processor, cause the processor to perform operations. The operations include obtaining an input core image, a formation bulk log of the log type, and a formation fluid log of a log type for a hydrocarbon reservoir. The operations further include determining, using a segmentation model and the input core image, a segmented core image to delineate a distribution along the reservoir, such that the distribution includes a lithology distribution, a mineralogy distribution, or a combination thereof. The operations further include determining, using the segmented core image, a volumetric log, such that the volumetric log includes a lithology volumetric log, a mineralogy volumetric log, or a combination thereof. The operations further include determining, using the volumetric log and a variable rock matrix value of the log type, a rock matrix log of the log type by assigning the variable rock matrix value of the log type to a lithology or mineralogy. The operations further include determining, using the rock matrix log of the log type, the formation bulk log of the log type, and the formation fluid log of the log type, a porosity log of the log type for the reservoir.

Other aspects and advantages of the claimed subject matter will be apparent from the following description and the appended claims.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

For a more complete understanding of this disclosure, reference is now made to the following brief description, taken in connection with the accompanying drawings and detailed description, wherein like reference numerals represent like parts.

FIG. 1 illustrates a schematic diagram of a reservoir environment in accordance with one or more embodiments.

FIG. 2 illustrates a schematic diagram of a transferring learning module in accordance with one or more embodiments.

FIG. 3 illustrates a schematic diagram of a machine learning system in accordance with one or more embodiments.

FIG. 4 illustrates a matrix density calculation workflow using a 360-degree core image in accordance with one or more embodiments.

FIG. 5 illustrates an initial limited photo set manual segmentation in accordance with one or more embodiments.

FIG. 6 illustrates a core image with poor automated segmentation in accordance with one or more embodiments.

FIG. 7 illustrates a flow chart that shows a process for determining a volumetric log to calculate a porosity log in accordance with one or more embodiments.

FIG. 8 illustrates a flow chart that shows a process for implementing a transfer learning convolution neural network (CNN)-based workflow in accordance with one or more embodiments.

FIG. 9 illustrates a functional block diagram of a computer system in accordance with one or more embodiments.

While certain embodiments will be described in connection with the illustrative embodiments shown herein, the subject matter of the present disclosure is not limited to those embodiments. On the contrary, all alternatives, modifications, and equivalents are included within the spirit and scope of the disclosed subject matter as defined by the claims. In the drawings, which are not to scale, the same reference numerals are used throughout the description and in the drawing figures for components and elements having the same structure.

### DETAILED DESCRIPTION

In the following description, for purposes of explanation, numerous specific details are set forth in order to provide a thorough understanding of the inventive concept. In the interest of clarity, not all features of an actual implementation are described. Moreover, the language used in this disclosure has been principally selected for readability and instructional purposes, and may not have been selected to delineate or circumscribe the inventive subject matter, resort to the claims being necessary to determine such inventive subject matter. Reference in this disclosure to “one embodiment” or to “an embodiment” or “another embodiment” means that a particular feature, structure, or characteristic described in connection with the embodiment is included in at least one embodiment of the disclosed subject matter, and multiple references to “one embodiment” or “an embodiment” or “another embodiment” should not be understood as necessarily all referring to the same embodiment.

This disclosure pertains to systems, methods, and computer-readable media for determining a porosity log of a log type for a hydrocarbon reservoir using 360-degree core photo data based on a convolution neural network (CNN) and transfer deep learning. Techniques disclosed herein may apply the CNN and transfer deep learning method to train a segmentation model to automatically segment a plurality of core images for the reservoir to determine a distribution along the wellbore according to lithology or mineralogy. Thus, a detailed rock matrix density log may be obtained using the distribution and a variable rock matrix density value which is unique per lithology or mineralogy. In contrast, traditional techniques usually assume a constant rock matrix density along the entire wellbore for porosity log calculation from a bulk density log. However, the constant rock matrix density assumption is unrepresentative of the rock matrix and causes large uncertainties in the porosity log calculation. The segmentation model disclosed herein provides an image-based automatic method to calculate an accurate porosity log of the log type using CNN and transfer deep learning.

Additionally, the segmentation model may be consistently improved using a transfer deep learning CNN-based workflow. In particular, an initial machine learning model is trained using a CNN to partition core images according to a lithology or mineralogy using a training dataset which includes an initial set of core images for the 360-degree core photo data. The initial set of core images may be first manually segmented by using a general purpose photo editing software. Thus, the initial machine learning model may be applied to a full set of core images for the 360-degree core photo data. Visual quality control may be conducted on the segmentation result over the full set of core images. For each core image, the segmentation result is validated when the trained segmentation model achieves an acceptable segmentation. Similarly, for each core image, the segmentation result is rejected when the trained segmentation model fails to achieve acceptable segmentation. When the trained segmentation model fails to achieve an acceptable segmentation, the core image is manually segmented to constitute a corrected set. Thus, the training dataset is augmented with the corrected set to retrain the segmentation model in an iterative transfer deep learning process until a predetermined criterion is met. As a result, the iterative transfer deep learning process of training, prediction, visual quality control, and transfer learning may be implemented to obtain a consistently improved segmentation model which may then be applied to the full set of core images for the reservoir.

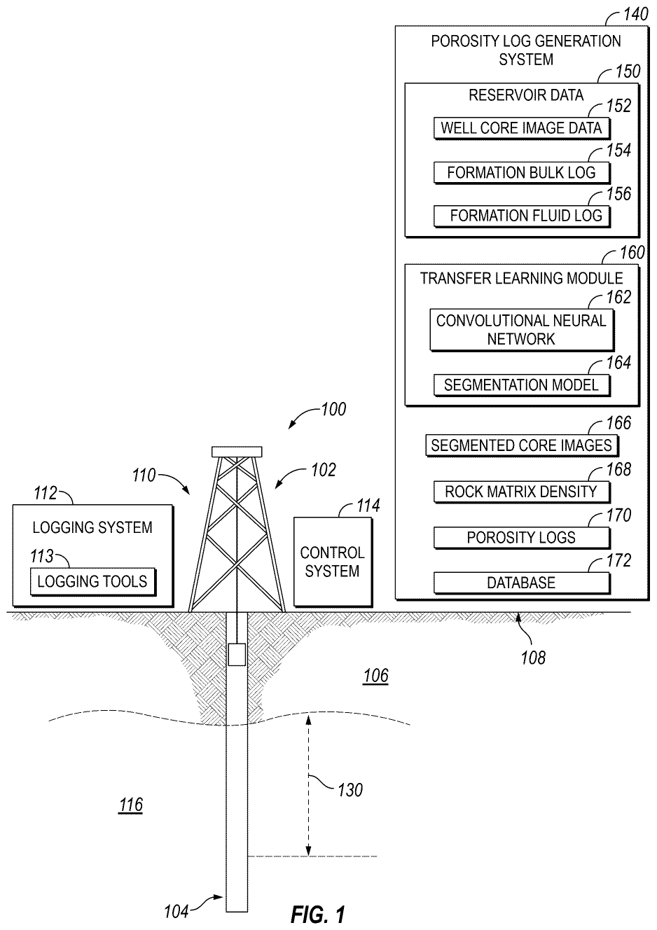

FIG. 1 is a diagram that illustrates a hydrocarbon reservoir environment (for example, reservoir environment or well environment) 100 in accordance with one or more embodiments. In the illustrated embodiment, reservoir environment 100 includes a hydrocarbon reservoir (“reservoir”) 116 located in a subsurface formation (“formation”) 106, and a hydrocarbon reservoir development system 110. Formation 106 may include a porous or fractured rock formation that resides underground, beneath the Earth's surface (“surface”) 108. Reservoir 116 may include a portion of formation 106 that contains (or that is determined to contain) a subsurface pool of hydrocarbons, such as oil and gas. Formation 106 and reservoir 116 may each include different rock layers having varying characteristics (for example, varying degrees of permeability, porosity, lithology, geology, or fluid saturation). Hydrocarbon reservoir development system 110, such as a drilling system, may facilitate the location and extraction (or “production”) of hydrocarbons from reservoir 116. Hydrocarbon reservoir development system 110 may include a drill string, a drill bit, a mud circulation system, and the like for use in extending wellbore 104 into formation 106.

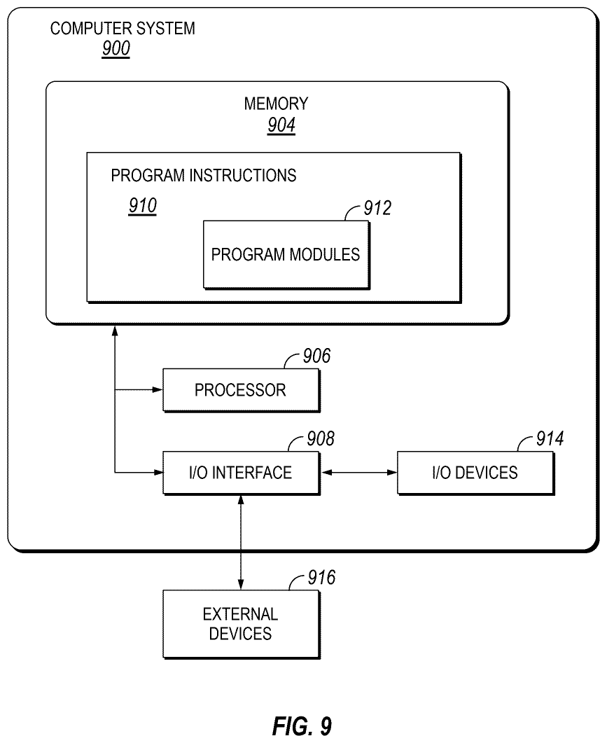

In some embodiments, hydrocarbon reservoir development system 110 includes a hydrocarbon reservoir control system (“control system”) 114 and (one or more) well 102. Control system 114 may include hardware, software, or a combination thereof for managing drilling operations, maintenance operations, or both. For example, control system 114 may include one or more programmable logic controllers (PLCs) that include hardware, software, or a combination thereof with functionality to control one or more processes performed by hydrocarbon reservoir development system 110. Specifically, a PLC may control valve states, fluid levels, pipe pressures, warning alarms, drilling parameters (for example, torque, weight on bit (WOB), stand pipe pressure (SPP), revolutions per minute (RPM), etc.), pressure releases throughout a drilling rig, or any combination thereof. In particular, a PLC may be a ruggedized computer system with functionality to withstand vibrations, extreme temperatures, wet conditions, or dusty conditions, for example, around a drilling rig. In some embodiments, control system 114 includes a computer system that is the same as or similar to that of computer system 900 described with regard to at least FIG. 9. Without loss of generality, the term “control system” may refer to a drilling operation control system that is used to operate and control the equipment, a drilling data acquisition and monitoring system that is used to acquire drilling process and equipment data and to monitor the operation of the drilling process, or a drilling interpretation software system that is used to analyze and understand drilling events and progress.

In some embodiments, control system 114 controls operations for developing reservoir 116. Although FIG. 1 illustrates control system 114 as being disposed at a location proximal to well 102, this may not be the case. For example, control system 114 may be provided at a remote location (for example, remote control center, core analysis lab, data center, server farm, and the like) that is remote from well 102. Control system 114 may control one or more formation evaluation operations (for example, well logging operations, core analysis operations, coring operations, and the like) used to acquire data from reservoir 116 and may control processing that automatically generates core description data based on core image data, and models and simulations generated based on data including image data of reservoir 116 that characterize the reservoir 116. Alternately, an external system may control processing to automatically generate core description data based on core image data of wellbore 104, and control system 114 may control and implement models and simulations generated based on the automatically generated core description data.

In some embodiments, control system 114 determines drilling parameters for well 102 in reservoir 116, determines operating parameters for well 102 in reservoir 116, controls drilling of well 102 in accordance with drilling parameters, or controls operating well 102 in accordance with the operating parameters. This can include, for example, control system 114 determining drilling parameters (for example, determining well location and trajectory) for reservoir 116, controlling drilling of well 102 in accordance with the drilling parameters (for example, controlling a well drilling system of the hydrocarbon reservoir development system 110 to drill well 102 at the well location and with wellbore 104 following the trajectory), determining operating parameters (for example, determining production rates and pressures for “production” well 102 and injection rates and pressure for “injection” well 102), and controlling operations of well 102 in accordance with the operating parameters (for example, controlling a well operating system of the hydrocarbon reservoir development system 110 to operate the production well 102 to produce hydrocarbons from reservoir 116 in accordance with the production rates and pressures determined for well 102, and controlling the injection well 102 to inject substances, such as water, into reservoir 116 in accordance with the injection rates and pressures determined for well 102).

In some embodiments, well 102 may include wellbore 104 that extends from surface 108 into a target zone of formation 106, such as reservoir 116. Wellbore 104 may be created, for example, by a drill bit boring along a path (or trajectory) through formation 106 and reservoir 116. In some embodiments, formation 106 may include various formation characteristics of interest, such as formation porosity, neutron, acoustic, optical, resistivity, nuclear magnetic resonance (NMR), formation permeability, water saturation, irreducible water saturation, rock type, temperature, density, and the like. Porosity may indicate how much space exists in a particular rock within an area of interest in formation 106, where oil, gas, water, or any combination thereof may be trapped. Neutron may indicate the amount of neutron radiation intensity related to the hydrogen content of rocks for a formation with the area of interest. Acoustic may indicate the travel time of an elastic wave through the rock within the area of interest. Optical may indicate the amount of light scattered back from the rock for a formation with the area of interest. Resistivity may indicate electrical resistivity for the rock within the area of interest. NMR may indicate the magnetization strength and the relaxation time for the rock within the area of interest. Permeability may indicate the ability of liquids and gases to flow through the rock within the area of interest. Water saturation may indicate the fraction of water in a given pore space. Irreducible water saturation may indicate the ratio of irreducible total fluid volume to effective porosity for a formation within the area of interest. Rock type may indicate the type of rock for a formation with the area of interest. For example, a tight chalk may have a greater strength property that requires a greater pump pressure for breaking the chalk. Temperature may indicate the temperature or the temperature gradient for a formation with the area of interest. Density may indicate the bulk density for a formation with the area of interest.

In some embodiments, reservoir environment 100 may include a logging system 112. Logging system 112 may include one or more logging tools 113, such as a neutron magnetic resonance (NMR) spectrometer, for use in generating well logs and core sample data of formation 106. Logging tools 113 may enable the characterization of fine-scale petrophysical properties data, such as density, porosity, permeability, rock type, water saturation, irreducible water saturation, etc. Logging tool 113 may be inserted into wellbore 104 or used in the laboratory to acquire measurements, such as well logs and core sample data as the tool traverses a depth interval 130, such as a targeted reservoir section of wellbore 104. The plot of the logging measurements versus depth may be referred to as a “log” or “well log.” Well logs may provide depth measurements of well 102 that describe such reservoir characteristics as formation porosity, formation permeability, resistivity, density, neutron, acoustic, optical, NMR, water saturation, total organic content (TOC), volume of kerogen, Young's modulus, Poisson's ratio, and the like. The resulting logging measurements may be stored, processed, or both, for example, by control system 114, to generate corresponding well logs for well 102. A well log may include, for example, a plot of a logging response time versus true vertical depth (TVD) across the depth interval 130 of wellbore 104.

Reservoir characteristics may be determined using a variety of different techniques. For example, certain reservoir characteristics, such as model parameters, may be determined via coring, such as physical extraction of rock samples, to produce core samples, logging operations, or both, such as wireline logging, logging-while-drilling (LWD), and measurement-while-drilling (MWD). Coring operations may include physically extracting a rock sample from a region of interest within wellbore 104 for detailed laboratory analysis. For example, when drilling an oil or gas well, a coring bit may cut plugs (or “cores” or “core samples”) from formation 106 and bring the plugs to the surface, and these core samples may be analyzed at the surface, such as in a lab, to determine various characteristics of the formation 106 at the location where the sample was obtained.

In some embodiments, reservoir environment 100 may include a porosity log generator system 140. Porosity log generation system 140 is configured to implement a segmentation model 164 to calculate a porosity log 170 of a log type using reservoir data 150, such as well core image data 152, a formation bulk log 154 of the log type, and a formation fluid log 156 of the log type for a hydrocarbon reservoir. For example, well core image data 152 includes a plurality of 360-degree well core images for the hydrocarbon reservoir. As another example, the log type includes density, neutron, acoustic, optical, resistivity, NMR, etc. In particular, porosity log generation system 140 is configured to utilize the well core image data 152 and segmentation model 164 to derive a rock matrix density log 168 of the log type for the reservoir. Porosity log generation system 140 may calculate the rock matrix density log 168 using a three step workflow: the first step is to develop a segmentation model 164 to generate a segmented core image 166 by automatically segmenting a core image from the well core image data 152 according to a lithology or mineralogy present in a core sample from the reservoir. For example, the segmented core image 166 may delineate a distribution along the reservoir. In particular, the distribution includes a lithology distribution, a mineralogy distribution, or a combination thereof. The second step is to convert the segmented core image 166 to a volumetric log which includes a lithology volumetric log, a mineralogy volumetric log, or a combination thereof. The third step is to derive the rock matrix density log 168 from the volumetric log and a plurality of universal values of the lithology or mineralogy based on equation 1. In particular, the rock matrix density log 168 may be determined by assigning the variable rock matrix value of the log type to a lithology or mineralogy. Thus, porosity log generation system 140 may calculate a porosity log 170 using the rock matrix density log 168, the formation bulk log 154 of the log type, and the formation fluid log 156 of the log type.

$${ρ}_{m} = {\sum }_{i ∈ lithology / mineralogy} {v}_{i} \times {ρ}_{i} \qquad ( 1 )$$

where vᵢ is the volume of lithology or mineralogy i, and ρᵢ is the density of a lithology or mineralogy i.

In some embodiments, porosity log generation system 140 is configured to generate the segmentation model 164 using a transfer learning module 160. In particular, the transfer learning module 160 includes a CNN 162 to train the segmentation model 164 to accurately partition the well core image data 152 according to a lithology or mineralogy into a plurality of segmented core images 166. Thus, the plurality of segmented core images 166 reflect a lithology or mineralogy distribution along the wellbore. By using a constant rock matrix density value per lithology or mineralogy which is stored in a database 172 (or other suitable structured data collection), a detailed rock matrix density log 168 is obtained. As a result, porosity log generation system 140 determines the detailed rock matrix density log 168 by implementing the plurality of segmented images 166 and a variable rock matrix density value which is unique per lithology or mineralogy.

In some embodiments, porosity log generation system 140 is configured to calculate one or more porosity logs 170, depending on the specific requirements of well data. The one or more porosity logs 170 may include a density porosity log, a neutron porosity log, an acoustic porosity log, an optical porosity log, a resistivity porosity log, a nuclear magnetic resonance (NMR) porosity log, or other porosity logs or combinations thereof. A density porosity log measures the gamma radiation intensity of a rock as a function of depth. The gamma radiation intensity is related to the electron density of the rock. Thus, the density porosity log may be used to estimate the porosity of the rock by calibrating the density log using rock samples from the well to estimate a formation bulk density ρ_{b}, a formation fluid density ρ_{f}, and a matrix density ρₘ based on equation 2.

$${∅}_{D e n} = \frac{{ρ}_{m} - {ρ}_{b}}{{ρ}_{m} - {ρ}_{f}} \qquad ( 2 )$$

where ρ_{b} is the formation bulk density, ρ_{f} is the formation fluid density, and ρₘ is the matrix density.

In some embodiments, for example, the formation bulk density ρ_{b} may be directly provided by the density log. In other embodiments, the formation fluid density ρ_{f} may be directly provided by laboratory analysis of the formation fluid. As will be appreciated, however, there is no logging tool to provide direct measurements to estimate the matrix density ρₘ for the rock. Conventionally, scattered laboratory measurements of the matrix density ρₘ are obtained from physical rock samples which are usually core. These scattered measurements are qualitatively and subjectively propagated for the entire wellbore to generate a synthetic matrix density log that can be used in equation 2. Thus, prior art techniques typically calculate a porosity log from a bulk density log by assuming a constant rock matrix density ρₘ along the entire wellbore. The constant rock matrix density ρₘ assumption is not representative of the entire rock matrix and causes large uncertainties in the porosity log calculation. Thus, embodiments of the disclosure improve the matrix density ρₘ estimation to accurately calculate the porosity of the rock.

In some embodiments, other types of porosity logs may be calculated in a similar approach as the density porosity log is calculated. For example, a neutron porosity log measures the neutron radiation intensity of a rock as a function of depth. The neutron radiation intensity is related to the porosity of the rock. Thus, the neutron porosity log may be used to estimate the porosity of the rock by calibrating the neutron log using rock samples from the well. As another example, an acoustic porosity log uses sound waves to measure the porosity of a rock. The log emits sound waves and measures the time it takes for the waves to travel through the rock and return to the surface. The time it takes for the waves to return is related to the porosity of the rock. As another example, an optical porosity log uses light to measure the porosity of a rock. The log emits light into the rock and measures the amount of light that is scattered back to the surface. The amount of light scattered is related to the porosity of the rock. As another example, a resistivity porosity log measures the electrical resistivity of a rock as a function of depth. The electrical resistivity is related to the porosity of the rock. Thus, the resistivity porosity log may be used to estimate the porosity of the rock by calibrating the resistivity log using samples from the well. As another example, the NMR porosity log uses nuclear magnetic resonance to measure the porosity of the rock. NMR is a technique that uses magnetic fields and radio waves to measure the properties of atoms in the rock. The NMR log can provide detailed information about the porosity and permeability of the rock.

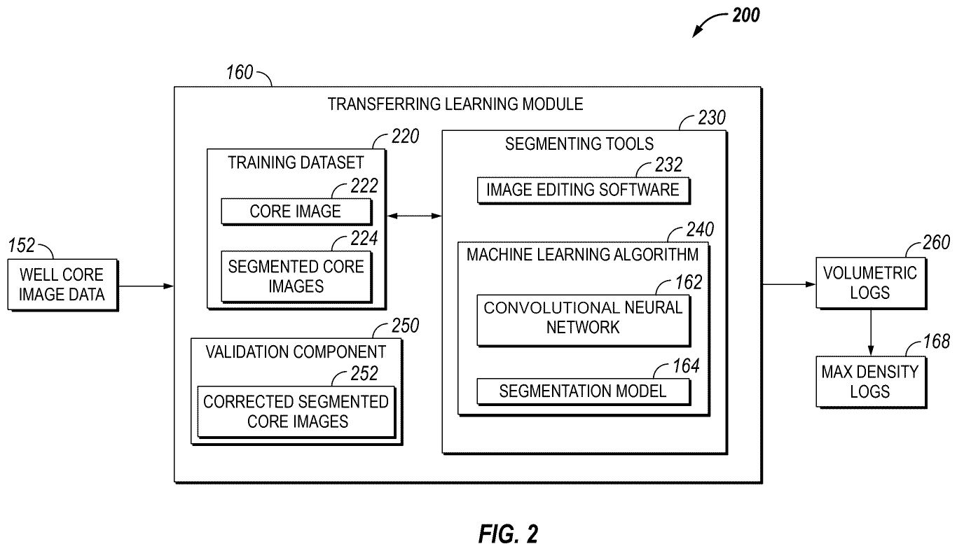

FIG. 2 illustrates a schematic diagram 200 of the transferring learning module 160 of FIG. 1 in accordance with one or more embodiments. The transferring learning module 160 may be implemented to train the segmentation model 164 using the convolutional neural network 162 and transferring deep learning to provide accurate segmentation of core photos from well core image data 152. In particular, a plurality of core images 222 may be chosen from the well core image data 152 for an initial set of core images which are first manually segmented using a segmenting tool 230 including an image editing software 232.

In some embodiments, transferring learning module 160 is configured to apply a machine learning algorithm, such as the convolutional neural network 162, to generate an initial model, such as segmentation model 164, to automatically partition core photos to a lithology or mineralogy using the plurality of core images 222 in the training dataset 220. Thus, the transferring learning module 160 may implement segmentation model 164 to determine a plurality of segmented core images 224 based on the initial trained model.

In some embodiments, transferring learning module 160 is configured to apply a validation component 250 to apply visual quality control on the plurality of segmented core images 224 over the full set of core images 222. For example, transferring learning module 160 may validate each of the plurality of segmented core images 224 based on a predetermined criterion or criteria (that is, any combination of the criterion). For example, the predetermined criterion may include shape, color, texture, or size associated with the anhydrite nodules as patchy cement in the core images. When a validation result is acceptable for a first core image, transferring learning module 160 may accept a corresponding segmented core image associated with the first core image. When a validation result is not acceptable for a second core image, transferring learning module 160 may reject a corresponding segmented core image associated with the second core image and manually segment the second core image to determine a corrected segmented image to augment the initial training dataset. Thus, the initial training dataset is augmented using the corrected segmented core images to retrain the segmentation model 164 in a transferring deep learning process which is implemented to consistently improve segmentation model 164 in multiple cycles of training, prediction, and visual quality control. As a result, a final trained model is used to segment the full set of core photos from well core image data 152 to determine a plurality of volumetric logs 260 based on the input well core image data 152. The depth resolution of the volumetric logs 260 is provided by the pixel size of the original core image in the input well core image data 152. The plurality of volumetric logs 260 show different lithology or mineralogy distributions along the wellbore. By using the plurality of volumetric logs 260 of the lithology or mineralogy and a plurality of universal values of the lithology or mineralogy, the detailed matrix density log 168 is obtained to include a variable rock matrix density value which is unique per lithology or mineralogy.

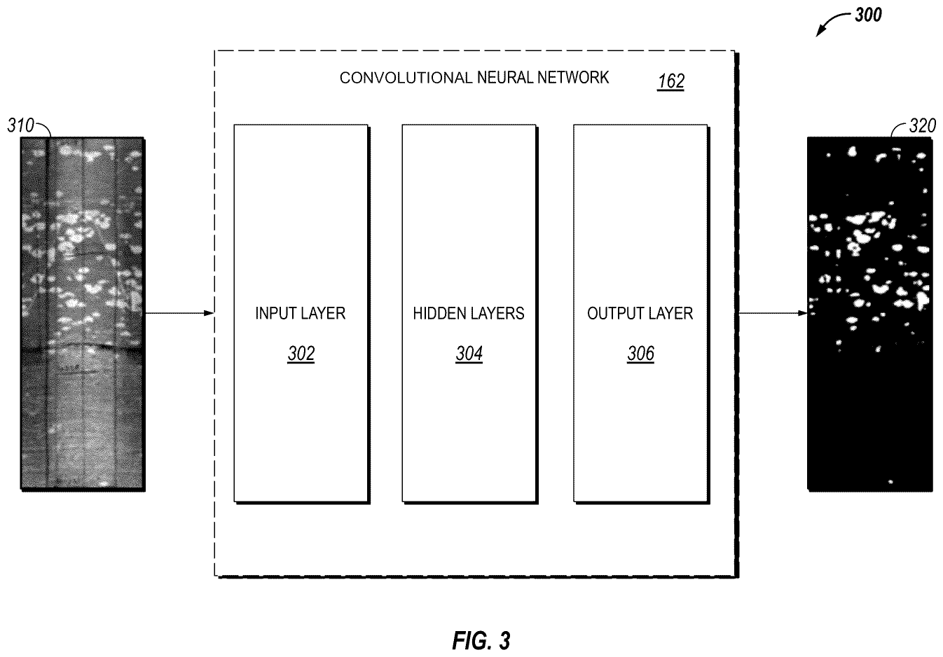

FIG. 3 illustrates a machine learning system 300 in accordance with one or more embodiments. Machine learning system 300 may include one or more machine learning models, such as the CNN 162 discussed herein. Machine learning system 300 uses CNN 162 to determine a segmented core image 320 based on an input 360-degree core image 310. In some embodiments, machine learning system 300 may include a plurality of layers, such as an input layer 302, one or more hidden layers 304, and an output layer 306. Input layer 302 may be programmed to receive the plurality of input parameters from machine learning system 300. In some embodiments, the one or more hidden layers 304 may include six hidden layers arranged sequentially from left to right, such as hidden layer A, hidden layer B, hidden layer C, hidden layer D, hidden layer E, and hidden layer F. For example, the hidden layer A is coupled between the input layer 302 and the hidden layer B, the hidden layer B is coupled between the hidden layer A and the hidden layer C, and so on. Thus, the hidden layer F is coupled between the hidden layer E and the output layer 306. Each of the one or more hidden layers 304 may be a convolutional layer, a pooling layer, a rectified linear unit (ReLU) layer, a softmax layer, a regressor layer, a dropout layer, or various other hidden layer types or combinations thereof. In other embodiments, the number of hidden layers may be greater than six or less than six. These hidden layers may be arranged in any suitable order sufficient to satisfy the input/output size criteria. Each layer may include a set number of image filters. The output of filters from each layer is stacked together in the third dimension, and this filter response stack then serves as the input to the next layer(s).

In some embodiments, the six hidden layers are configured according to the following: The hidden layer A and the hidden layer B may be down-sampling blocks to extract high-level features from the input data set. The hidden layer D and the hidden layer E may be up-sampling blocks to output the classified or predicted output data set. The hidden layer C may perform residual stacking as a bottleneck between down-sampling blocks (for example, hidden layer A, hidden layer B) and up-sampling blocks (for example, hidden layer D, hidden layer E). The hidden layer F may include a softmax layer or a regressor layer to classify or predict a predetermined class or a value based on input attributes.

In some embodiments, in a convolutional layer, the input data set is convolved with a set of learned filters that are designed to highlight specific characteristics of the input data set. A pooling layer produces a scaled-down version of the output by considering small neighborhood regions and applying a desired operation filter (e.g., min, max, mean, etc.) across the neighborhood. A ReLU layer enhances a nonlinear property of the network by introducing a non-saturating activation function. One example of such a non-saturating function is to threshold out negative responses (that is, set negative values to zero). A fully connected layer provides high-level reasoning by connecting each node in the layer to all activation nodes in the previous layer. A softmax layer maps the inputs from the previous layer into a value between 0 and 1 or between −1 and 1. Therefore, a softmax layer allows for interpreting the outputs as probabilities and selection of classified facie with the greatest probability. In some embodiments, a softmax layer may apply a symmetric sigmoid transfer function to each element of the raw outputs independently to interpret the outputs as probabilities in the range of values between −1 and 1. A dropout layer offers a regularization technique for reducing network over-fitting on the training data by dropping out individual nodes with a certain probability. A loss layer (for example, utilized in training) defines a weight-dependent cost function that needs to be optimized (that is, bring the cost down toward zero) for improved accuracy. In some embodiments, each hidden layer may be a combination of a convolutional layer, a pooling layer, and a ReLU layer in a multilayer architecture. As an example and not by way of limitation, each hidden layer has a convolutional layer, a pooling layer, and a ReLU layer.

In some embodiments, machine learning system 300 may include an activation function in a ReLU layer (for example, hidden layer F) to calculate the misfit function based on the difference between the predicted friction value and ground truth (for example, a value of “0”). In some embodiments, machine learning system 300 may use a data split technique to separate the input data used for the training, validation, and testing of CNN 162. For example and not by way of limitation, the data split technique may consider 70% of the input data for model training (for example, tuning of the model parameters), 15% of the obtained input data for validation (for example, performance validation for each different set of model parameters), and 15% of the obtained input data for testing the final trained model. However, the data split technique may be appropriately adjusted (for example, by the user) to prevent over-fitting that results in CNN 162 with limited generalization capabilities (for example, models that underperform when predicting unseen sample data). Thus, other embodiments may use different percentages of input data for model training, model validation, and model testing.

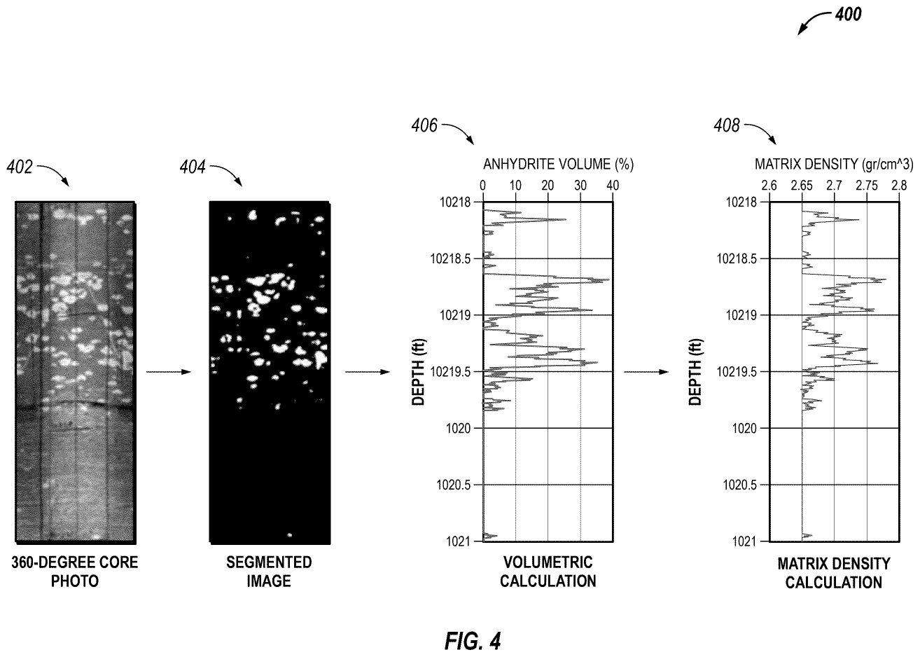

FIG. 4 illustrates a matrix density calculation workflow 400 using a 360-degree core image in accordance with one or more embodiments. The matrix density calculation workflow includes three major steps. In the first step, the matrix density calculation workflow 400 includes implementing a segmentation model to automatically partition a 360-degree core image 402 for a core sample from a wellbore into a segmented image 404 according to a lithology or mineralogy present in the core sample. In particular, the segmented image 404 reflects a lithology or mineralogy distribution along the wellbore. The segmentation model may be trained using CNN and transferring deep learning. The hyperparameters of the CNN may be optimized and fine-tuned using a testing dataset including a plurality of well core images from the wellbore. In the second step, the matrix density calculation workflow 400 includes converting the segmented image 404 into a detailed volumetric log 406 according to a lithology or mineralogy. The depth resolution of the volumetric log is provided by the pixel size of the original core photo. In the third step, the matrix density calculation workflow 400 includes deriving a porosity log 408 from the lithology or mineralogy volumetric log and a plurality of universal values for the lithology or mineralogy present in the core sample based on equation 1. For example, the segmentation model may be trained to accurately quantify a plurality of anhydrite nodules in segmented images from one or more input well core images, such as borehole images, 360-degree core photos, and resistivity borehole images. Thus, the one or more input well core images are used to provide a detailed rock matrix density log which is used to calculate an accurate porosity log.

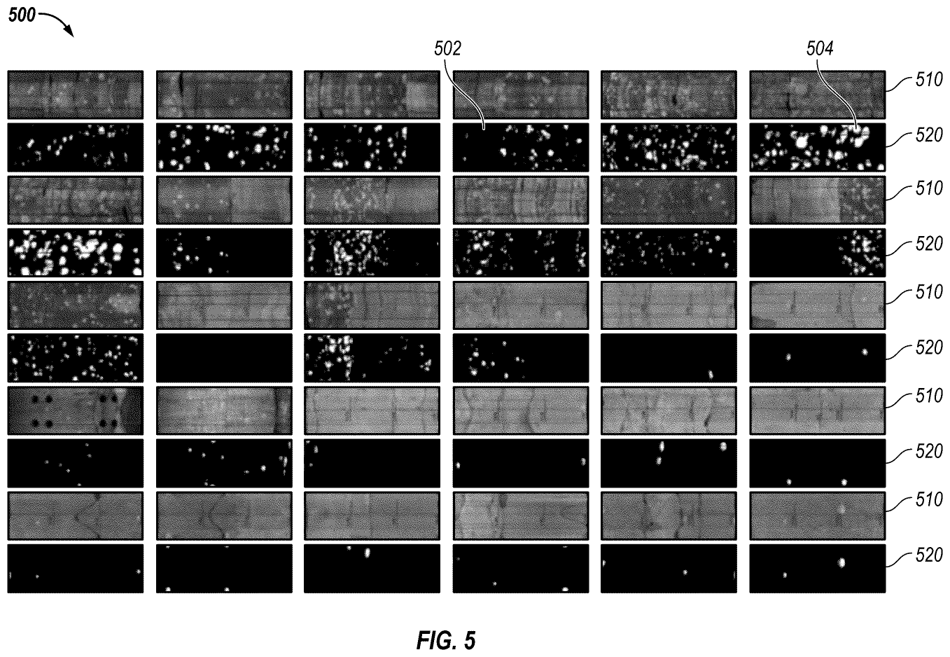

FIG. 5 illustrates an initial limited photo set manual segmentation 500 in accordance with one or more embodiments. A plurality of segmented images 520 are manually segmented using a general purpose photo editing software based on a plurality of well core images 510. In particular, the plurality of segmented images 520 show a sandstone matrix 502 and a plurality of anhydrite nodules 504 as patchy cement.

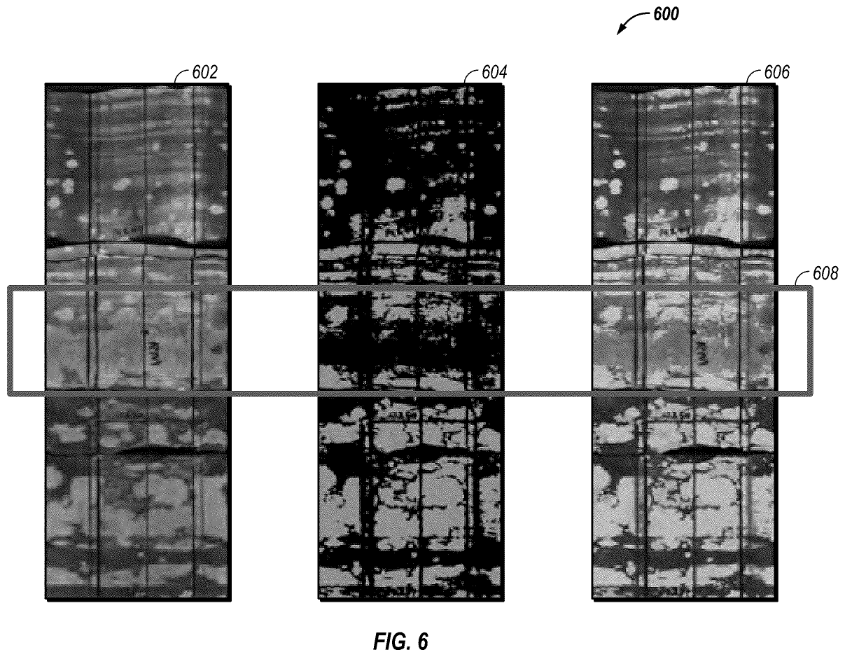

FIG. 6 illustrates a core image with poor automated segmentation 600 in accordance with one or more embodiments. A segmentation model is trained to determine a first segmented image 604 by partitioning an initial core image 602 from a wellbore to a lithology or mineralogy. The initial trained model is used to automatically segment a full set of core images from the wellbore, such as a second segmented image 606 for a different core image from the full set of core images. Visual quality control may be conducted on the initial trained model result over a full set of core images. However, in the example shown in FIG. 6, the initial trained model result may be identified as not acceptable in the rectangle region 608. Thus, manual segmentation may be used to segment the initial core image 602 to provide more accurate segmentation.

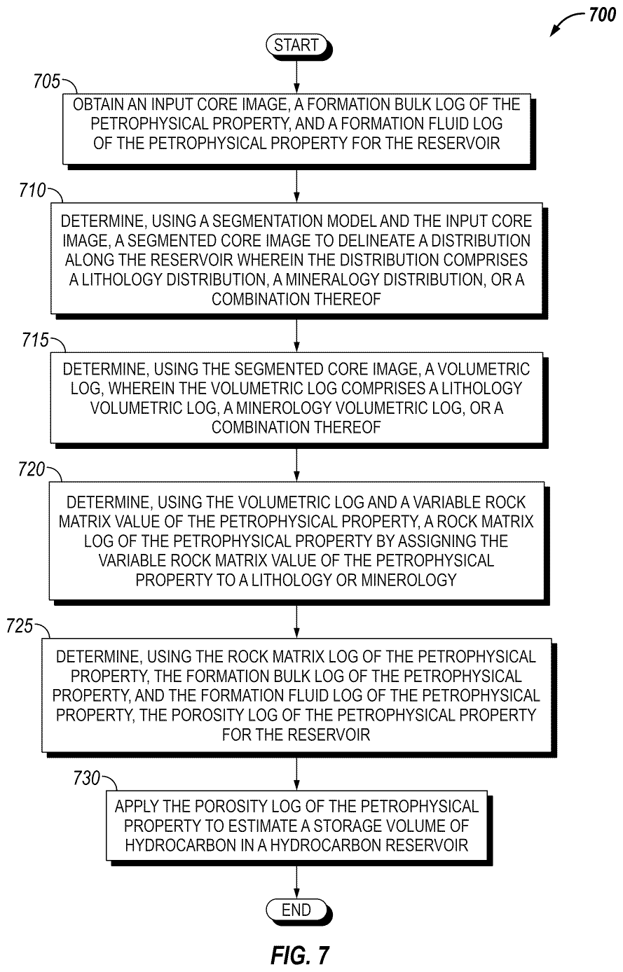

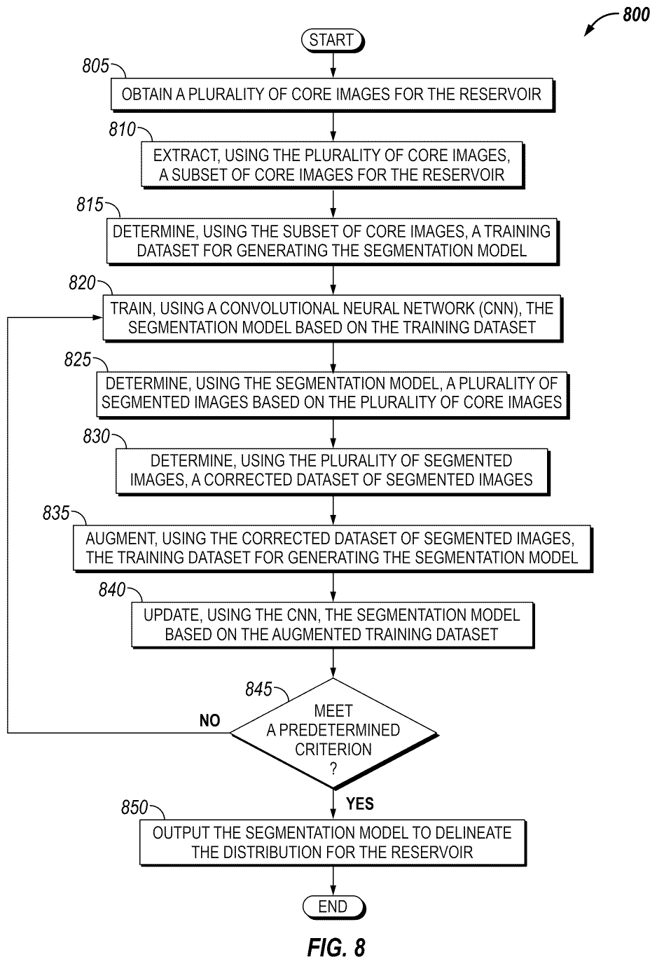

FIGS. 7 and 8 depict various processes in accordance with the present techniques. While the various blocks in FIGS. 7 and 8 are presented and described sequentially, some or all of the blocks may be executed in different orders, may be combined or omitted, and some or all of the blocks may be executed in parallel. Furthermore, the blocks may be performed actively or passively.

FIG. 7 illustrates a flow chart that shows a process 700 for determining a volumetric log to calculate a porosity log in accordance with one or more embodiments. In some embodiments, a segmentation model described in the disclosure is implemented to determine a porosity log of a log type using core photo data. At block 705, the process 700 includes obtaining an input core image, a formation bulk log of the log type, and a formation fluid log of the log type for the reservoir. The log type may include density, neutron, acoustic, optical, resistivity, NMR, etc. For example, the input core image includes a 360-degree core photo, a borehole image, or a resistivity borehole image for a core sample from the reservoir. As another example, the formation bulk log includes a density log which provides formation bulk density for the core sample from the reservoir. As another example, the formation fluid log includes a plurality of fluid densities directly provided by a laboratory analysis of the formation fluid. In particular, the plurality of fluid densities are affected by dissolved solids, dissolved gases, compressibility, and temperature. Dissolved solids and fluid compressibility increase density, whereas dissolution of gasses and thermal expansion caused by increased heat content reduce density. For example, the density of fresh water is about 1.0 grams per cubic centimeter (g/cm³). As another example, the density of salt water is about 1.1 g/cm³. As another example, the density of oil is about 0.9 g/cm³.

At block 710, the process 700 includes determining a segmented core image to delineate a distribution along the reservoir by using a segmentation model and the input core image. In particular, the distribution includes a lithology distribution, a mineralogy distribution, or a combination thereof. The segmentation model is trained based on CNN and transfer deep learning to automatically partition the input core image according to a lithology or mineralogy to derive a detailed rock matrix density log.

At block 715, the process 700 includes determining a volumetric log using the segmented core image. The volumetric log includes a lithology volumetric log, a mineralogy volumetric log, or a combination thereof. The depth resolution of the volumetric log is determined by the pixel size of the original input core image.

At block 720, the process 700 includes determining a rock matrix log of the log type by using the volumetric log and a variable rock matrix value of the log type. In particular, the rock matrix log of the log type is obtained by assigning a unique variable rock matrix value of the log type to a lithology or mineralogy. For example, the rock matrix log may include a rock matrix density log which has densities in a range between 2.65 g/cm³ to 2.8 g/cm³ for anhydrite nodules in the core sample from the reservoir. Thus, the process 700 may calculate the rock matrix log of the log type by summing the respective variable rock matrix value of the log type for a plurality of lithology or mineralogy components for the reservoir. The respective variable rock matrix value of the log type is determined by multiplying a volume of the respective lithology or mineralogy and a value of the log type of the respective lithology or mineralogy. In particular, the plurality of lithology or mineralogy components include sandstone and anhydrite.

At block 725, the process 700 includes determining the porosity log of the log type for the reservoir by using the rock matrix log of the log type, the formation bulk log of the log type, and the formation fluid log of the log type. The process 700 may determine the porosity of the log type based on equation 2. In particular, the process 700 may determine a first difference between the rock matrix log of the log type and the formation bulk log of the log type. The process 700 may determine a second difference between the rock matrix log of the log type and the formation fluid log of the log type. The process 700 may determine the porosity log of the log type by dividing the first difference by the second difference.

At block 730, the process 700 includes applying the porosity log of the log type to estimate a storage volume of hydrocarbon in a hydrocarbon reservoir.

Particular embodiments may repeat one or more steps of the method of FIG. 7, where appropriate. Although this disclosure describes and illustrates particular steps of the method of FIG. 7 as occurring in a particular order, this disclosure contemplates any suitable steps of the method of FIG. 7 occurring in any suitable order. Moreover, although this disclosure describes and illustrates an example method to determine a porosity log of a log type using core photo data based on the segmentation model described in the disclosure, including the particular steps of the method of FIG. 7, this disclosure contemplates any suitable method including any suitable steps, which may include all, some, or none of the steps of the method of FIG. 7, where appropriate. Furthermore, although this disclosure describes and illustrates particular components, devices, or systems carrying out particular steps of the method of FIG. 7, this disclosure contemplates any suitable combination of any suitable components, devices, or systems carrying out any suitable steps of the method of FIG. 7.

FIG. 8 illustrates a flow chart that shows a process 800 for implementing a transfer learning CNN-based workflow in accordance with one or more embodiments. In some embodiments, the transfer learning CNN-based workflow is implemented to obtain a consistently improvement segmentation model using a full set of core photos. At block 805, the process 800 includes obtaining a plurality of core images for the reservoir. For example, the plurality of core images are associated with anhydrite nodules as patchy cement for a photo set including multiple borehole images, 360-degree core images, resistivity borehole images, or a combination thereof.

At block 810, the process 800 includes extracting a subset of core images for the reservoir using the plurality of core images. In particular, the process 800 may determine an initial set of core images for training the segmentation model by using the subset of core images for the reservoir. For example, the process 800 may extract the subset of core images by using 30% core images of the full set of core images based on prior experience of a user. As another example, the process 800 may extract the subset of core images by randomly selecting 30% core images of the full set of core images.

At block 815, the process 800 includes determining a training dataset for generating the segmentation model using the subset of core images. In some embodiments, the process 800 may manually segment the subset of core images by using a general purpose photo editing software. The manually segmented core images may be used as the training dataset for training an initial machine learning model to partition core images according to a lithology or mineralogy. Thus, the process 800 may generate the training dataset by creating an encoded dataset using the subset of core images and the plurality of segmented images associated with the subset of core images.

At block 820, the process 800 includes training the segmentation model based on the training dataset using a CNN. The process 800 may use the CNN to train the segmentation model using the training dataset. In particular, the CNN includes a plurality of parameters which are tuned to automatically partition a core image into the anhydrite nodules as patchy cement and the sandstone as matrix.

At block 825, the process 800 includes determining a plurality of segmented images based on the plurality of core images using the segmentation model. In particular, the process 800 may determine the plurality of segmented images by applying the segmentation model to automatically segment the full set of core images based on the plurality of core images.

At block 830, the process 800 includes determining a corrected dataset of segmented images using the plurality of segmented images. The process 800 may apply a visual quality control to validate each of the plurality of segmented images. For example, a segmented image is acceptable when the classification result of the segmented image reaches a predetermined success threshold, such as 90%. As another example, the segmented image is not acceptable when the classification result of the segmented image is below a predetermined success threshold, such as 90%. Thus, the segmented image is rejected and manually segmented correctly to be added to the corrected dataset of segmented images.

At block 835, the process 800 includes augmenting the training dataset for generating the segmentation model using the corrected dataset of segmented images. The process 800 may improve the quality of the training dataset by augmenting the training dataset using the corrected dataset of segmented images.

At block 840, the process 800 includes updating the segmentation model based on the augmented training dataset using the CNN. The process 800 may apply the CNN to update the segmentation model in a cycle of transfer learning based on the augmented training dataset. Thus, the quality of the segmentation model may be improved by improving the quality of the training dataset.

At block 845, a determination is made whether the segmentation model meets a predetermined criterion. For example, the predetermined criterion is a classification possibility, such as a value of 0.95, of the segmentation model for successfully partitioning the full set of core images. Where the predetermined criterion is met, the process may proceed to block 850. Where the predetermined criterion is not met, the process may proceed to block 820. At block 855, the process 800 includes outputting the segmentation model to delineate the distribution for the reservoir. In particular, the process 800 may use the final segmentation model to classify all the lithologies present in the wellbore for the reservoir.

Particular embodiments may repeat one or more steps of the method of FIG. 8, where appropriate. Although this disclosure describes and illustrates particular steps of the method of FIG. 8 as occurring in a particular order, this disclosure contemplates any suitable steps of the method of FIG. 8 occurring in any suitable order. Moreover, although this disclosure describes and illustrates an example method to implement a transfer learning CNN-based workflow based on the segmentation model described in the disclosure, including the particular steps of the method of FIG. 8, this disclosure contemplates any suitable method including any suitable steps, which may include all, some, or none of the steps of the method of FIG. 8, where appropriate. Furthermore, although this disclosure describes and illustrates particular components, devices, or systems carrying out particular steps of the method of FIG. 8, this disclosure contemplates any suitable combination of any suitable components, devices, or systems carrying out any suitable steps of the method of FIG. 8.

FIG. 9 is a functional block diagram of a computer system (or “system”) 900 in accordance with one or more embodiments. In some embodiments, system 900 is a programmable logic controller (PLC). System 900 may include memory 904, processor 906, and input/output (I/O) interface 908. Memory 904 may include non-volatile memory (for example, flash memory, read-only memory (ROM), programmable read-only memory (PROM), erasable programmable read-only memory (EPROM), electrically erasable programmable read-only memory (EEPROM)), volatile memory (for example, random access memory (RAM), static random access memory (SRAM), synchronous dynamic RAM (SDRAM)), or bulk storage memory (for example, CD-ROM or DVD-ROM, hard drives). Memory 904 may include a non-transitory computer-readable storage medium (for example, a non-transitory program storage device) having program instructions 910 stored thereon. Program instructions 910 may include program modules 912 that are executable by a computer processor (for example, processor 906) to cause the functional operations described, such as those described with regard to porosity log generation system 140, process 700, or process 800.

Processor 906 may be any suitable processor capable of executing program instructions. Processor 906 may include a central processing unit (CPU) that carries out program instructions (for example, the program instructions of the program modules 912) to perform the arithmetical, logical, or input/output operations described. Processor 906 may include one or more processors. I/O interface 908 may provide an interface for communication with one or more I/O devices 914, such as a joystick, a computer mouse, a keyboard, or a display screen (for example, an electronic display for displaying a graphical user interface (GUI)). I/O devices 914 may include one or more of the user input devices. I/O devices 914 may be connected to I/O interface 908 by way of a wired connection (for example, an Industrial Ethernet connection) or a wireless connection (for example, a Wi-Fi connection). I/O interface 908 may provide an interface for communication with one or more external devices 916. In some embodiments, I/O interface 908 includes one or both of an antenna and a transceiver. In some embodiments, external devices 916 include logging tools, lab test systems, well pressure sensors, well flowrate sensors, or other sensors described in connection with hydrocarbon reservoir development system 110.

Further modifications and alternative embodiments of various aspects of the disclosure will be apparent to those skilled in the art in view of this description. Accordingly, this description is to be construed as illustrative only and is for the purpose of teaching those skilled in the art the general manner of carrying out the embodiments. It is to be understood that the forms of the embodiments shown and described herein are to be taken as examples of embodiments. Elements and materials may be substituted for those illustrated and described herein, parts and processes may be reversed or omitted, and certain features of the embodiments may be utilized independently, all as would be apparent to one skilled in the art after having the benefit of this description of the embodiments. Changes may be made in the elements described herein without departing from the spirit and scope of the embodiments as described in the following claims. Headings used herein are for organizational purposes only and are not meant to be used to limit the scope of the description.

It will be appreciated that the processes and methods described herein are example embodiments of processes and methods that may be employed in accordance with the techniques described herein. The processes and methods may be modified to facilitate variations of their implementation and use. The order of the processes and methods and the operations provided may be changed, and various elements may be added, reordered, combined, omitted, modified, and so forth. Portions of the processes and methods may be implemented in software, hardware, or a combination of software and hardware. Some or all of the portions of the processes and methods may be implemented by one or more of the processors/modules/applications described here.

As used throughout this application, the word “may” is used in a permissive sense (that is, meaning having the potential to), rather than the mandatory sense (that is, meaning must). The words “include,” “including,” and “includes” mean including, but not limited to. As used throughout this application, the singular forms “a,” “an,” and “the” include plural referents unless the content clearly indicates otherwise. Thus, for example, reference to “an element” may include a combination of two or more elements. As used throughout this application, the term “or” is used in an inclusive sense, unless indicated otherwise. That is, a description of an element including A or B may refer to the element including one or both of A and B. As used throughout this application, the phrase “based on” does not limit the associated operation to being solely based on a particular item. Thus, for example, processing “based on” data A may include processing based at least in part on data A and based at least in part on data B, unless the content clearly indicates otherwise. As used throughout this application, the term “from” does not limit the associated operation to being directly from. Thus, for example, receiving an item “from” an entity may include receiving an item directly from the entity or indirectly from the entity (for example, by way of an intermediary entity). Unless specifically stated otherwise, as apparent from the discussion, it is appreciated that throughout this specification discussions utilizing terms such as “processing,” “computing,” “calculating,” “determining,” or the like refer to actions or processes of a specific apparatus, such as a special purpose computer or a similar special purpose electronic processing/computing device. In the context of this specification, a special purpose computer or a similar special purpose electronic processing/computing device is capable of manipulating or transforming signals, typically represented as physical, electronic, or magnetic quantities within memories, registers, or other information storage devices, transmission devices, or display devices of the special purpose computer or similar special purpose electronic processing/computing device.

At least one embodiment is disclosed and variations, combinations, modifications of the embodiment(s), or features of the embodiment(s) made by a person having ordinary skill in the art are within the scope of the disclosure. Alternative embodiments that result from combining, integrating, or omitting features of the embodiment(s) are also within the scope of the disclosure. Where numerical ranges or limitations are expressly stated, such express ranges or limitations may be understood to include iterative ranges or limitations of like magnitude falling within the expressly stated ranges or limitations (for example, from about 1 to about 10 includes, 2, 3, 4, etc.; greater than 0.10 includes 0.11, 0.12, 0.13, etc.). The use of the term “about” (or its variants) means ±10% of the subsequent number, unless otherwise stated.

Use of the term “optionally” with respect to any element of a claim means that the element is required, or alternatively, the element is not required, both alternatives being within the scope of the claim. Use of broader terms such as comprises, includes, and having may be understood to provide support for narrower terms such as consisting of, consisting essentially of, and comprised substantially of. Accordingly, the scope of protection is not limited by the description set out above but is defined by the claims that follow, that scope including all equivalents of the subject matter of the claims. Each and every claim is incorporated as further disclosure into the specification and the claims are embodiment(s) of the present disclosure.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise.

Many other embodiments will be apparent to those of skill in the art upon reviewing the above description. The scope of the subject matter of the present disclosure therefore should be determined with reference to the appended claims, along with the full scope of equivalents to which such claims are entitled. In the appended claims, the terms “including” and “in which” are used as the plain-English equivalents of the respective terms “comprising” and “wherein.”

What is claimed is:

1. A method for determining a porosity log of a log type for a hydrocarbon reservoir, comprising:
obtaining an input core image, a formation bulk log of the log type, and a formation fluid log of the log type for the reservoir;
determining, using a segmentation model and the input core image, a segmented core image to delineate a distribution along the reservoir, wherein the distribution comprises a lithology distribution, a mineralogy distribution, or a combination thereof;
determining, using the segmented core image, a volumetric log, wherein the volumetric log comprises a lithology volumetric log, a mineralogy volumetric log, or a combination thereof;
determining, using the volumetric log and a variable rock matrix value of the log type, a rock matrix log of the log type by assigning the variable rock matrix value of the log type to a lithology or mineralogy; and
determining, using the rock matrix log of the log type, the formation bulk log of the log type, and the formation fluid log of the log type, the porosity log of the log type for the reservoir.

2. The method of claim 1, further comprising:
applying the porosity log of the log type to estimate a storage volume of hydrocarbon in the hydrocarbon reservoir.

3. The method of claim 1, wherein the segmentation model is generated using a transfer deep learning workflow, the transfer deep learning workflow comprising:
obtaining a plurality of core images for the reservoir;
extracting, using the plurality of core images, a subset of core images for the reservoir;
determining, using the subset of core images, a training dataset for generating the segmentation model; and
performing a plurality of iterations to update the segmentation model until a predetermined criterion is met, each of the plurality of iterations comprising:
training, using a convolutional neural network (CNN), the segmentation model based on the training dataset;
determining, using the segmentation model, a plurality of segmented images based on the plurality of core images;
determining, using the plurality of segmented images, a corrected dataset of segmented images;
augmenting, using the corrected dataset of segmented images, the training dataset for generating the segmentation model; and
updating, using the CNN, the segmentation model based on the augmented training dataset; and
outputting the segmentation model to delineate the distribution for the reservoir.

4. The method of claim 3, the transfer deep learning workflow further comprising:
manually segmenting, using the subset of core images, a plurality of segmented images associated with the subset of core images.

5. The method of claim 4, the transfer deep learning workflow further comprising:
generating the training dataset by creating an encoded dataset using the subset of core images and the plurality of segmented images associated with the subset of core images.

6. The method of claim 1, wherein the volumetric log has a depth resolution which is equal to a pixel size of the input core image.

7. The method of claim 1, further comprising:
calculating the matrix log of the log type by summing the respective variable rock matrix value of the log type for a plurality of lithology or mineralogy components for the reservoir, wherein the respective variable rock matrix value of the log type is determined by multiplying a volume of the respective lithology or mineralogy and a value of the log type of the respective lithology or mineralogy.

8. The method of claim 7, wherein the plurality of lithology or mineralogy components comprises sandstone and anhydrite.

9. The method of claim 1, further comprising:
determining a first difference between the rock matrix log of the log type and the formation bulk log of the log type; and
determining a second difference between the rock matrix log of the log type and the formation fluid log of the log type; and
determining the porosity log of the log type by dividing the first difference by the second difference.

10. The method of claim 1, wherein the log type comprises density, neutron, acoustic, optical, resistivity, or nuclear magnetic resonance (NMR).

11. A system for determining a porosity log of a log type for a hydrocarbon reservoir, comprising:
a processor; and
a computer-readable non-transitory storage medium comprising instructions that, when executed by the processor, cause the processor to perform operations comprising:
obtaining an input core image, a formation bulk log of the log type, and a formation fluid log of the log type for the reservoir;
determining, using a segmentation model and the input core image, a segmented core image to delineate a distribution along the reservoir, wherein the distribution comprises a lithology distribution, a mineralogy distribution, or a combination thereof;
determining, using the segmented core image, a volumetric log, wherein the volumetric log comprises a lithology volumetric log, a mineralogy volumetric log, or a combination thereof;
determining, using the volumetric log and a variable rock matrix value of the log type, a rock matrix log of the log type by assigning the variable rock matrix value of the log type to a lithology or mineralogy; and
determining, using the rock matrix log of the log type, the formation bulk log of the log type, and the formation fluid log of the log type, the porosity log of the log type for the reservoir.

12. The system of claim 11, the operations further comprising:
applying the porosity log of the log type to estimate a storage volume of hydrocarbon in the hydrocarbon reservoir.

13. The system of claim 11, wherein the segmentation model is generated using a transfer deep learning workflow, the transfer deep learning workflow comprising:
obtaining a plurality of core images for the reservoir;
extracting, using the plurality of core images, a subset of core images for the reservoir;
determining, using the subset of core images, a training dataset for generating the segmentation model; and
performing a plurality of iterations to update the segmentation model until a predetermined criterion is met, each of the plurality of iterations comprising:
training, using a convolutional neural network (CNN), the segmentation model based on the training dataset;
determining, using the segmentation model, a plurality of segmented images based on the plurality of core images;
determining, using the plurality of segmented images, a corrected dataset of segmented images;
augmenting, using the corrected dataset of segmented images, the training dataset for generating the segmentation model; and
updating, using the CNN, the segmentation model based on the augmented training dataset; and
outputting the segmentation model to delineate the distribution for the reservoir.

14. The system of claim 13, the transfer deep learning workflow further comprising:
manually segmenting, using the subset of core images, a plurality of segmented images associated with the subset of core images.

15. The system of claim 14, the transfer deep learning workflow further comprising:
generating the training dataset by creating an encoded dataset using the subset of core images and the plurality of segmented images associated with the subset of core images.

16. The system of claim 11, wherein the volumetric log has a depth resolution which is equal to a pixel size of the input core image.

17. The system of claim 11, the operations further comprising:
calculating the rock matrix log of the log type by summing the respective variable rock matrix value of the log type for a plurality of lithology or mineralogy components for the reservoir, wherein the respective variable rock matrix value of the log type is determined by multiplying a volume of the respective lithology or mineralogy and a value of the log type of the respective lithology or mineralogy.

18. The system of claim 11, wherein the log type comprises density, neutron, acoustic, optical, resistivity, or nuclear magnetic resonance (NMR).

19. The system of claim 11, the operations further comprising:
determining a first difference between the rock matrix log of the log type and the formation bulk log of the log type; and
determining a second difference between the rock matrix log of the log type and the formation fluid log of the log type; and
determining the porosity log of the log type by dividing the first difference by the second difference.

20. A non-transitory computer-readable medium comprising instructions that are configured, when executed by a processor, to perform operations comprising:
obtaining an input core image, a formation bulk log of the log type, and a formation fluid log of a log type for a hydrocarbon reservoir;
determining, using a segmentation model and the input core image, a segmented core image to delineate a distribution along the reservoir, wherein the distribution comprises a lithology distribution, a mineralogy distribution, or a combination thereof;
determining, using the segmented core image, a volumetric log, wherein the volumetric log comprises a lithology volumetric log, a mineralogy volumetric log, or a combination thereof;
determining, using the volumetric log and a variable rock matrix value of the log type, a rock matrix log of the log type by assigning the variable rock matrix value of the log type to a lithology or mineralogy; and
determining, using the rock matrix log of the log type, the formation bulk log of the log type, and the formation fluid log of the log type, a porosity log of the log type for the reservoir.
